(19) United States
(12) Patent Application Publication
(10) Pub. No.: US 2024/0306657 A1
(43) Pub. Date: Sep. 19, 2024

(54) REDUCED SUGAR WHITE CHOCOLATE CONFECTIONERY PRODUCTS AND METHODS FOR MAKING THE SAME

(71) Applicant: THE HERSHEY COMPANY, Hershey, PA (US)

(72) Inventors: Xiaoying WANG, Hershey, PA (US); Balaji SANTHANAM, Hershey, PA (US); James F. ST. JOHN, Hershey, PA (US); Rebecca THOMAS, Hershey, PA (US); Burton Douglas BROWN, Hershey, PA (US)

(73) Assignee: THE HERSHEY COMPANY, Hershey, PA (US)

(21) Appl. No.: 18/606,847

(22) Filed: Mar. 15, 2024

Related U.S. Application Data
(60) Provisional application No. 63/490,651, filed on Mar. 16, 2023.

(51) Int. Cl. A23G 1/40; A23G 1/00; A23G 1/46

(52) U.S. Cl. CPC A23G 1/40; A23G 1/0036; A23G 1/46

(57) ABSTRACT

The present disclosure relates to reduced sugar content white chocolate confectionery products comprising at least one rare sugar, such as allulose, methods of making the same wherein the confectionery products have desirable rheological properties, organoleptic properties, stable apparent viscosity, stable plastic viscosity, stable yield value, and coloring over time. The present disclosure also relates to preventing thickening or gelling of reduced sugar content white chocolate confectionery products comprising at least one rare sugar, such as allulose, during manufacturing, and maintaining stable apparent viscosity, stable plastic viscosity, and stable yield value over time.

### CROSS-REFERENCE TO RELATED APPLICATIONS

This application is a Non-Provisional Patent Application which claims benefit to U.S. Provisional Patent Application No. 63/490,651, filed on Mar. 16, 2023, the entire contents of which are incorporated herein by reference.

### TECHNICAL FIELD

The present disclosure generally relates to reduced sugar content white chocolate confectionery products and methods of making the same. The present disclosure also relates to a method for preventing or inhibiting thickening or gelling, formation of agglomerates, and/or discoloration of reduced sugar content white chocolate confectionery products comprising at least one rare sugar, such as allulose, during manufacturing and/or storage.

### BACKGROUND OF THE INVENTION

The Standard of Identity (SOI) for white chocolate established by the US Food and Drug Administration (FDA) became effective on Jan. 1, 2004. “White chocolate” has been defined by the FDA as products made from cacao fat (i.e., cocoa butter), milk solids, nutritive carbohydrate sweeteners, and other safe and suitable ingredients, but containing no nonfat cacao solids. 67 FR 62171, Oct. 4, 2002. White chocolate is gaining popularity globally in the United States and the market is expected to grow steadily with increasing consumption of white chocolate. Healthy eating trends have been driving innovation in the sugar-free/reduced sugar category as consumers seek healthier snacking options. White chocolate confections having a reduced sugar content would therefore be appealing. Sugar reduction in chocolate is commonly achieved using sugar alcohols which can sometimes be associated with unwanted laxative effects. Additionally, white chocolates with sugar alcohols do not meet the SOI hurdles in most countries. That is, white chocolates containing sugar alcohols cannot be labeled as “White Chocolate” since sugar alcohols are not allowed in “Standard of Identity” chocolates. As a result, there is a desire to find a non-polyol sugar substitute for white chocolate confectionery products having a reduced sugar content.

### BRIEF SUMMARY OF THE INVENTION

This section provides a general summary of the disclosure and is not a comprehensive disclosure of its full scope or all of its features.

In various aspects, the present teachings provide a white chocolate confectionery product having a reduced sugar content comprising a fat ingredient, a sweetener, an emulsifier/surfactant; and an optional dairy ingredient, bulk filler, intense sweetener, whitening agent, and/or flavor. The sweetener comprises at least one rare sugar, or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, D-mannose, trehalose, and kojibiose.

The white chocolate confectionery product, as measured by Brookfield viscometer, has an apparent viscosity at 40° C. and 20 rpm of 1,000 to 15,000 cp, a plastic viscosity at 40° C. using the National Confectionery Association and Chocolate Manufacturers Association (“NCA/CMA”) Casson regression model of 500 to 10,000 cp, and stable yield value at 40° C. using the NCA/CMA Casson regression model of 0.5-150 dynes/cm².

The white chocolate confectionery products of the present disclosure, have stable apparent viscosity, stable plastic viscosity, and stable yield value at temperatures of from about 100° F. (38° C.) to about 122° F. (50° C.) for at least two weeks. In some examples the white chocolate confectionery product of the disclosure is stable at temperatures from about 100° F. (38° C.) to about 113° F. (45° C.) for up to 4 weeks. Additionally, there is substantially no discoloration at elevated storage temperatures from above 40° C. for at least one week as measured by ΔE≤3.0.

The present disclosure also relates to a method for making a white chocolate confectionery product having a reduced sugar content, the method comprising: mixing a predetermined amount of a fat ingredient and a predetermined amount of sweetener and other dry bulk ingredients; refining the fat/sweetener/dry bulk mixture to obtain a particle size of <60 μm; adding a predetermined amount of emulsifier/surfactant to the refined fat/sweetener/dry bulk mixture; conching at a conching temperature of less than 50° C. for a predetermined conching time; and standardizing with remaining emulsifiers/surfactants and fats. The “other dry bulk ingredients” are other dry ingredients than sweeteners, which can include bulk fillers, intense sweeteners, flavors, etc.

The sweetener comprises at least one rare sugar or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, and D-mannose to obtain a fat/sweetener/dry bulk mixture.

The white chocolate confectionery product made according to the method of the present disclosure as measured by Brookfield viscometer, has an apparent viscosity at 40° C. and 20 rom of 1,000 to 15,000 cp, a plastic viscosity at 40° C. using the NCA/CMA Casson regression model of 500 to 10,000 cp, and yield value at 40° C. using the NCA/CMA Casson regression model of 0.5-150 dynes/cm². Additionally, the apparent viscosity, plastic viscosity, and yield are stable at temperatures of from about 100° F. (38° C.) to about 122° F. (50° C.) for at least two weeks. In some examples the white chocolate confectionery product of the disclosure is stable at temperatures from about 100° F. (38° C.) to about 113° F. (45° C.) for up to 4 weeks. Additionally, there is substantially no discoloration at elevated storage temperatures from above 40° C. for at least one week as measured by ΔE≤3.0.

The present disclosure also relates to a method of preventing or inhibiting thickening of white chocolate confectionery product which comprises a sweetener comprising at least one rare sugar or a combination of at least one rare sugar and at least one standard nutritive carbohydrate sugar (zero sugar or sugar free products do not allow sugar), said method comprising: conching at a temperature of less than 50° C. for a predetermined time; adding fat in an amount of about 30% by weight or more, overdosing the white chocolate confectionery product with an emulsifier/surfactant (i.e., providing higher than usual amounts of emulsifiers/surfactants to the white chocolate), and/or reducing total moisture of the white chocolate confectionery product to below 2.0%. The at least one rare sugar is selected from the group consisting of allulose, tagatose, allose, sorbose, apiose, ribose, L-rhamnose, L-fructose, D-mannose, trehalose, and kojibiose.

The white chocolate confectionery product of the present disclosure, as measured by Brookfield viscometer, has an apparent viscosity at 40° C. and 20 rpm of 1,000 to 15,000 cp, plastic viscosity at 40° C. using the NCA/CMA Casson regression model of 500 to 10,000 cp, and yield value at 40° C. using the NCA/CMA Casson regression model of 1-150 dynes/cm².

Additionally, the apparent viscosity, plastic viscosity, and yield value are stable at temperatures of from about 100° F. (38° C.) for at least two weeks. In some examples, the white chocolate confectionery product of the disclosure is stable at temperatures from about 100° F. (38° C.) to about 122° F. (50° C.) for up to 4 weeks. In other examples, the apparent viscosity, plastic viscosity, and yield value are stable at a temperature of from above 100° F. (38° C.) to about 113° F. (45° C.) for up to 4 weeks. Moreover, there is substantially no discoloration at elevated storage temperatures from above 40° C. for at least one week as measured by ΔE≤3.0.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The various advantages of the embodiments will become apparent to one skilled in the art by reading the following specification and appended claims, and by referencing the following drawings in which:

FIGS. 1A and 1B illustrate thickened white chocolate containing allulose.

FIG. 2 is a graph illustrating a comparison of the calculated color difference (ΔE) between the white chocolate confectionery product paste samples at time 0 and at time n weeks for the control including crème powder vs. variant samples wherein the crème powder is replaced with polydextrose (1a), replaced with ½ polydextrose and ½ CaCO₃ (1b), replaced with CaCO₃ (1c), and wherein a small amount of TiO₂ is added to the crème powder (1d).

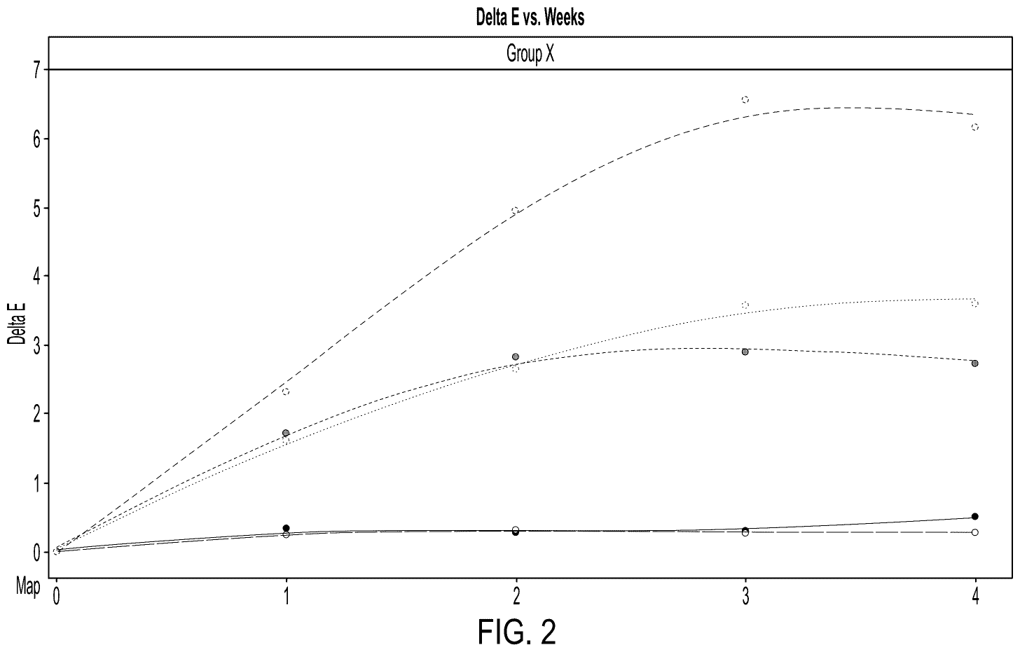

### DETAILED DESCRIPTION OF THE INVENTION

The present disclosure provides white chocolate confectionery products having a reduced sugar content and methods for making the same. For purposes of this disclosure, the term “white chocolate confectionery product” includes SOI white chocolate and non SOI white chocolate. Rare sugars are a sweetening ingredient that enable lower sugar content levels or calories on nutrition labels while still providing the taste and texture attributes desired by consumers. To be successful, white chocolate confectionery product with at least one rare sugar (including combinations of rare sugars) should possess rheological properties i.e., the flow properties, similar to typical white chocolate confectionery products to work within typical chocolate processing systems. White chocolate confectionery with at least one rare sugar should also meet, as measured by Brookfield viscometer, has an apparent viscosity at 40° C. and 20 rpm of 1,000 to 15,000 cp, plastic viscosity and yield values at 40° C., which range from 500-10,000 cp and 1-150 dynes/cm², respectively, for typical white chocolate confectionery products using the NCA/CMA Casson regression model. For purposes of this disclosure, “white chocolate confection” or “white chocolate confections” and “white chocolate confectionery product” or “white chocolate confectionery products” are used interchangeably. Additionally, “white chocolate”, “white chocolate coating”, “white chocolate candy”, “white compound chocolate”, “white chocolate confections” and “white chocolate paste” may be used interchangeably as non-standard of identity white chocolate for purposes of this disclosure.

The rheological characteristics, i.e., flow properties, of chocolate are important. Chocolate is non-Newtonian in nature, which means that it flows differently depending on how it is stirred, pumped, or how quickly it is poured. These characteristics are described by measurements of yield value, i.e., how much force is needed to start the chocolate flowing, and plastic viscosity, i.e., an approximation of the work done to keep the chocolate flowing uniformly. If either the yield value or the plastic viscosity is outside of the prescribed ranges, poor processing will result. J. Chevall, J. Texture Studies, 6: 177-196, “Rheology of Chocolate (1975).

A typical process for making chocolate involves mixing, refining, conching or liquefying chocolate, standardizing, and tempering to obtain the desired rheology and proper fat crystal morphologies needed for standard processes of enrobing, molding, or producing various shapes of chocolate confections. During processing, a standardized chocolate is typically stored in large tanks at elevated temperatures, such as e.g., 40° C. or higher for extended periods of time, such as up to 4 weeks, with periodic stirring followed by pumping the chocolate to the tempering units. Thus, it is important for the chocolate to maintain the desired, stable rheological properties throughout processing and in-processing storage.

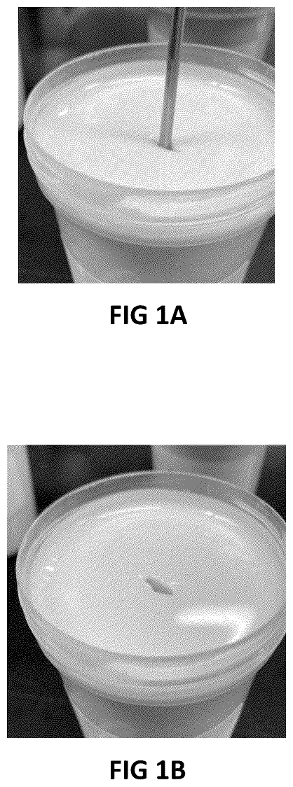

The present inventors have unexpectedly found that white chocolate sweetened with at least one rare sugar, such as allulose, is significantly different in viscosity than typical white chocolate after being held at elevated temperatures for extended periods of time, such as e.g., 45° C. for 4 weeks or 50° C. for up to 2 weeks. For example, white chocolate sweetened with at least one rare sugar, such as allulose, turns into a thick, unflowable, viscous gel in a time frame of only a few days. The rheological properties (i.e., apparent, plastic viscosities, and yield value) increase beyond the range of a typical chocolate or such that the measured properties increase by 200% or more throughout the first two weeks of storage, this could lead to processing difficulties, such as pipe blocking, pumping issues in production, transportation, and application of the chocolate, and/or render the chocolate unusable. See FIGS. 1A and 1B, which show white chocolate with a 25% reduction in sugar by replacing the sugar content with allulose, which turned into an unflowable gel when stored at 45° C. or 50° C. for about 1 week without agitation. A spatula can stand up in the unflowable gel formed by the white chocolate having a reduced sugar content by replacing sugar with allulose and stored at 45° C. or 50° C. for about 1 week without agitation as can be seen in FIG. 1A. As the spatula was removed a hole was left in the unflowable white chocolate as can be seen in FIG. 1B.

Additionally, it was found by the present inventors that white chocolate sweetened with a rare sugar, such as allulose, showed significant discoloration when stored at elevated temperatures for extended periods of time, such as e.g., above 45° C. for more than about 1 week, i.e., 7 days. The present inventors also observed that white chocolate sweetened with a rare sugar, such as allulose forms agglomerates, i.e., hard chocolate grits during conching at typical conching temperatures of 50° C. or above.

To address these problems, the present disclosure provides methods for preventing or inhibiting thickening or gelling, formation of agglomerates, and/or discoloration of reduced sugar content white chocolate confectionery products comprising at least one rare sugar, such as allulose, during manufacturing and/or storage. The methods include adding fat in an amount of about 30% by weight or more, overdosing the white chocolate with emulsifiers/surfactants (i.e., providing higher than usual amounts of emulsifiers/surfactants to the white chocolate), reducing the total moisture of the white chocolate to below 2.0%, minimizing the content of protein-containing ingredients such that the finished white chocolate has a protein content of less than about 1.0%, and/or conching at temperatures lower than typical conching temperatures, such as 48° C. for the entire conch period, or at least at the initial stage of conching. A white chocolate confectionery product with at least one rare sugar of the present disclosure will have a stable apparent viscosity at 40° C. and 20 rpm of 1,000 to 15,000 cp stable plastic viscosity, and stable yield value at 40° C. of 500-10,000 cp or 600-10,000 cp, or 1,000-10,000 cp and 1-150 dynes/cm², respectively, using the NCA/CMA Casson regression model when prepared by the aforementioned methods. The term “stable” within the phrases “stable apparent viscosity”, “stable plastic viscosity”, and “stable yield” means that any changes to apparent viscosity, plastic viscosity, and yield are maintained within an acceptable range such that downstream processing such as pumping, tempering, molding, etc., are not affected; and/or that any changes to apparent viscosity, plastic viscosity, yield, and color are maintained such that the confectionery product remains in a flowable state and aesthetically pleasing during storage for at least two weeks.

The present disclosure provides a white chocolate confectionery product, which contains a fat ingredient, a sweetener comprising at least one rare sugar, a combination of rare sugars, a combination of rare sugar and sugar alcohols, or a combination of at least one rare sugar and at least one standard nutritive carbohydrate sugar, an edible emulsifier/surfactant, and an optional dairy ingredient, bulk filler and/or flavor, wherein the white chocolate confectionery product as measured by Brookfield viscometer, has a stable apparent viscosity at 40° C. and 20 rpm of 1,000 to 15,000 cp, a stable plastic viscosity and yield value at 40° C. of 500-10,000 cp, and 1-150 dynes/cm², respectively, using the NCA/CMA Casson regression model.

Viscosity is a measurement of a fluid's resistance to flow. It is a quantity expressing the magnitude of friction between particles which are moving at different velocities. Viscosity directly affects chocolate utility in certain applications. In order to achieve certain quality parameters, chocolate or confectionery coating products must have specific flow properties. Viscosity is measured by a Brookfield viscometer in accordance with ICA Method 46. From the data, one can calculate plastic viscosity, the chocolate's resistance to flow, and yield value, the stress necessary to induce flow, using the NCA/CMA Casson regression model. For purposes of this disclosure, viscosity refers to “apparent viscosity”, “plastic viscosity” and “rheology” and “rheological properties” refer to overall flow behavior described by any of apparent or plastic viscosity or yield value (used interchangeably with “yield”).

Apparent viscosity values describe singular data points at particular shear rates and are widely used for materials such as chocolate whose flow behavior is dependent upon shear conditions. In the confectionery industry, this value is defined as the viscosity at 20 rpm measured at a standardized temperature (40° C.) and is used as a single data point to compare relative flow behavior amongst chocolates. The white chocolate confectionery products of the present disclosure can have an apparent viscosity at 40° C. and 20 rpm (as measured by Brookfield viscometer) in the range of 1,000 to 15,000 cp, or in the range of 3,000 to 12,000 cp or 4,000 to 10,000 cp. The white chocolate confectionery products of the present disclosure additionally have a plastic viscosity at 40° C. (as calculated by the NCA/CMA Casson regression) in the range of 500-10,000 cp, or 600-10,000, or 1,000 to 10,000 cp. Additionally, the plastic viscosity and yield value of the white chocolate confectionery products of the present disclosure are stable at temperatures from about 100° F. (38° C.) to about 122° F. (50° C.) for at least two weeks. In some examples the white chocolate confection of the disclosure is stable at temperatures from about 100° F. (38° C.) to about 113° F. (45° C.) for up to 4 weeks. Additionally, there is substantially no discoloration at elevated storage temperatures from above 40° C. for at least one week as measured by ΔE≤3.0.

Chocolate viscosity is typically measured using a Brookfield viscometer with concentric cylinder geometry, most commonly using an SC4-27 spindle. The instrument will generally have some method of temperature control, such as a water jacketed small sample adapter, to set the temperature to 40° C. during testing. The viscometer is traditionally programmed to first warm up the chocolate sample to 40° C., pre-shear at a lower shear rate for a defined time, then at a high shear rate for a defined time followed by gradually decreasing shear rates. A typical method uses a 16 g chocolate sample, warming to 40° C. for 2 minutes, then pre-shear at 50 rpm (17 1/s shear rate) for 3 minutes, followed by measuring shear stress at 100 rpm (34 1/s shear rate), 50 rpm (17 1/s shear rate), 20 pm (6.8 1/s shear rate), 10 rpm (3.4 1/s shear rate), and 5 rpm (1.7 1/s shear rate). The program could vary slightly depending on the laboratory. While the testing temperature of 40° C. is relatively constant throughout the industry, the remaining test parameters (i.e., shear rates and hold times) can fluctuate slightly depending on the laboratory, instrument, and/or individual chocolate samples.

From the data, one can obtain rheological values such as apparent viscosity, plastic viscosity, and yield value. Apparent viscosity at 20 rpm of chocolate is defined as the 20 rpm value measured on the Brookfield viscometer and is typically reported in centi-Poise (cp). Although the SI unit for shear rate is reciprocal seconds (1/s), some instruments such as the Brookfield are programmed in terms of spindle rotations per minute (rpm). It is possible to convert between the two units using the geometry and dimensions of the spindle and cup. If there is both an up and down ramp of shear rate, the 20 rpm value on the down ramp will typically be reported as the apparent viscosity. Additionally, data is typically fitted to the National Confectioners Association/Chocolate Manufacturers Association (NCA/CMA) Casson model to calculate plastic viscosity and yield value. Plastic viscosity is defined as the resistance to flow and is an indication of how readily a chocolate will continue flowing once in motion, reported in centi-Poise. The yield value is the stress (force per area) needed to initiate flow and is typically reported in dynes/cm². Apparent viscosity at 20 rpm, plastic viscosity, and yield are of importance to the confectioner as they are indications of a chocolate's suitability to various processes such as pumping, enrobing, and molding. The intended use of the chocolate impacts the optimum apparent viscosity at 20 rpm, plastic viscosity, and yield value desired. As such, if a chocolate's rheological properties substantially increase from its optimum values (based on its intended use) over storage, it may become unusable.

Stability in terms of the white chocolate confectionery products of the present disclosure refers to possessing and/or maintaining acceptable rheological properties, i.e., flowability at temperatures from about 100° F. (38° C.) to about 122° F. (50° C.) for at least about two (2) weeks. In some examples the white chocolate confection of the disclosure is stable at temperatures from about 100° F. (38° C.) to about 113° F. (45° C.) for up to 4 weeks.

The white chocolate confectionery products of the present disclosure include a fat ingredient. A fat ingredient refers to naturally occurring fats and oils such as cocoa butter, pressed cocoa butter, expeller cocoa butter, solvent extracted cocoa butter, refined cocoa butter, and the like, also cocoa butter equivalents, cocoa butter substitutes and/or cocoa butter replacers, including but not limited to, fractionated palm oil, palm kernel oil, shea oil, sunflower oil, safflower oil, illipe oil, and the like, or hydrogenated vegetable oils. Reduced calorie fat alternatives, such as Salatrim (short and long-chain acyl triglyceride molecules) and EPG (esterified propoxylated glycerols), and modified plant-based oil, can also be used in this application.

The white chocolate confectionery products of the present disclosure include a sweetener comprising at least one rare sugar (including combinations of rare sugars), or a combination of at least one rare sugar and at least one standard nutritive carbohydrate sugar. The at least one rare sugar is selected from the group consisting of allulose, tagatose, allose, sorbose, apiose, ribose, L-rhamnose, L-fructose, D-mannose, trehalose, and kojibiose and combinations thereof. In some examples of the present disclosure, the rare sugar is allulose. In other examples of the present disclosure, the rare sugar is tagatose. For purposes of this disclosure, a standard nutritive carbohydrate sugar is a common carbohydrate sugar with varying degrees of sweetness intensity useful in the present disclosure, which can be any of those typically used in the art and include, but are not limited to, sucrose, (e.g., from cane or beet), dextrose, fructose, lactose, maltose, glucose syrup solids, corn syrup solids, hydrolyzed lactose, maple sugar, brown sugar, and the like, and combinations thereof. The at least one standard nutritive carbohydrate sugar, preferably sucrose, will be present in the chocolate as crystals or particles.

The particle size of the ingredients, especially the sweetener, and more specifically the particle size of the at least one rare sugar, such as allulose, can influence the viscosity of the chocolate. Particle sizes can be measured by various techniques known to those skilled in the art. These techniques include the MALVERN® and SYMPATEC® light scattering techniques, measurement using a micrometer and measurement using a microscope and the like. Unless otherwise specified herein, when referring to the particle size distribution of the sweetener comprising at least one rare sugar, a combination of rare sugars, or a combination of at least one rare sugar and at least one standard nutritive carbohydrate sugar, and white chocolate confections, the measurements were taken using the SYMPATEC® laser light scattering technique. Furthermore, unless otherwise specified herein, when referring to the particle size of the finished white chocolate, the measurements were taken using a micrometer. In some examples, the particle size of the sweetener comprising at least one rare sugar, a combination of rare sugars, or a combination of at least one rare sugar and at least one standard nutritive carbohydrate sugar, and a nonfat milk solid are within a certain specified range in order to maintain specified rheological properties. In some examples, the particle size of the sweetener comprising at least one rare sugar, a combination of rare sugars, or a combination of at least one rare sugar and at least one standard nutritive carbohydrate sugar, and a nonfat milk solid may be less than 60 microns, less than 50 microns, less than 40 microns, less than 30 microns, or equal to or greater than 20 microns. In some examples, the particle size of the sweetener comprising at least one rare sugar, a combination of rare sugars, or a combination of at least one rare sugar and at least one standard nutritive carbohydrate sugar, and a nonfat milk solid is within the range of 20-45 microns or 20-35 microns.

The white chocolate confectionery products of the present disclosure contain emulsifiers/surfactants. For purposes of this disclosure, the terms “emulsifier” and “surfactant” are used interchangeably, and the term “emulsifier/surfactant” refers to “emulsifier” or “surfactant” or both “emulsifier and surfactant”. Examples of safe and suitable emulsifiers/surfactants can be any of those typically used in the art and include lecithin derived from vegetable sources such as soybean, sunflower, oat, etc., fractionated lecithins enriched in either phosphatidyl choline or phosphatidyl ethanolamine or both, polyglycerol polyricinoleate (PGPR), mono- and digylcerides, monosodium phosphate derivatives of mono- and diglycerides of edible fats or oils, sorbitan monostearate, polyoxyethylene sorbitan monostearate, hydroxylated lecithin, lactylated fatty acid esters of glycerol and propylene glycol, polyglycerol esters of fatty acids, propylene glycol mono-and diester of fats and fatty acids or any emulsifier/surfactant that may become approved for the USFDA-defined soft candy category. In addition, other emulsifiers/surfactants that can be used in the present disclosure, include polyglycerol polyricinoleate (PGPR), ammonium salts of phosphatidic acid including ammonium phosphatide (AMP), sucrose esters, oat extract, etc., and any emulsifier found to be suitable in chocolate or a similar fat/solid system or any blend in an amount sufficient to achieve the desired effects. Emulsifiers/surfactants preferred for use in the present disclosure are lecithin, PGPR, and combinations or mixtures of these emulsifiers/surfactants.

Once a white chocolate is refined and conched, small doses of emulsifier/surfactants are added and mixed in well. Then the rheological measurements are taken. This procedure, also known as standardization, is continued until the apparent viscosity, plastic viscosity, and yield value reaches predetermined ranges. The recommended level of emulsifier/surfactant is the level at which apparent viscosity at 20 rpm the plastic viscosity, and yield value are proper for processing of a specific chocolate product. The most common emulsifier/surfactant, soy lecithin will lower plastic viscosity and yield value to a point at proper usage level. Beyond its optimum use level, lecithin will cause an increase in yield value. Chocolate makers do not add additional lecithin beyond this optimum level due to possible issues in downstream processes that higher yield values will cause. The inventors discovered that higher levels than the traditional white chocolate optimum levels for suitable apparent viscosity, plastic viscosity, and yield value will prevent allulose white chocolate from thickening. In some examples of the present disclosure, the emulsifier/surfactant content is from about 0.4% to about 0.9% by weight or from 0.5% to about 0.9% by weight. It should be noted that when allulose is used at lower levels, less emulsifier/surfactant will be needed. For example, a small batch of allulose white chocolate (AWC) was prepared in the lab. The lecithin and PGPR levels to achieve proper apparent viscosity, plastic viscosity, and yield value were initially determined to be 0.3% by weight and 0.1% by weight, respectively, based on the flow properties of the chocolate at the end of conching. This AWC thickened over time. However, when the lecithin and PGPR levels were increased from about 0.4% to about 0.9% by weight and PGPR from about 0.1% to about 0.3% by weight, respectively, the AWC did not thicken over time.

In some examples, the emulsifier/surfactant employed in the white chocolate confectionery products of the present disclosure comprises a combination of lecithin and PGPR, said combination having a content of lecithin of about 0.3% to about 0.6% by weight, and a content of PGPR of about 0.1% to about 0.3% by weight. In yet some other examples, the emulsifier/surfactant of the present disclosure comprises a combination of lecithin and PGPR, said combination having a content of about 0.6% lecithin by weight and about 0.3% PGPR by weight, and the confectionery product having a moisture content of about 1.2% to about 2.0% by weight or about 1.5% to about 2.0% by weight. When the moisture content is higher than 2.0% by weight, the white chocolate confectionery product is more likely to have significant color change or browning.

The white chocolate confectionery products of the present disclosure may additionally contain optional ingredients. These optional ingredients include, but are not limited to, dairy ingredients, nonfat milk solids, sugar substitutes, bulk fillers, flavors, and combinations thereof. The “optional ingredients” are sometimes referred to as “dry bulk ingredients” in the present disclosure. For purposes of this disclosure, “dry bulk ingredients”, “other bulk ingredients”, “bulk ingredients”, “bulk fillers” and “bulk” may be used interchangeably.

Optional dairy ingredients include, but are not limited to, cream, milkfat, and butter; milk, including but not limited to, dry whole milk and dry skim milk; nonfat dry milk; dried buttermilk; malted milk; whey; milk permeate; milk fat; and milk proteins.

Optional bulk fillers, also called bulking agents include, but not limited to flour, starch, modified starch, fiber, pea powder, polydextrose, cellulose, fructooligosaccharides, inulin, dextrin, sugar alcohols, and combinations or mixtures thereof; natural and artificial flavors (e.g., vanillin, spices, coffee, ethyl vanillin, salt, brown nut-meats, natural vanilla, etc., as well as mixtures of these). In some examples of the present disclosure, the bulk filler comprises a protein content of less than 20.0% by weight. The protein content in the finished white chocolate in some examples is less than 1.0% by weight. In some examples where a whitening agent is added, the protein content can be higher.

Optional sugar substitutes may also be included. Sugar substitutes taste sweet but do not contain sugar and typically have fewer calories. Optional sugar substitutes include but are not limited to intense sweeteners and sugar alcohols. Intense sweeteners are typically many times sweeter than table sugar (sucrose). Smaller amounts of intense sweeteners are needed to achieve the same level of sweetness as sugar. Intense sweeteners include, but are not limited to stevia, monk fruit, aspartame, acesulfame potassium (Ace-K) neotame, saccharin, sucralose, and advantame. Sugar alcohols may also be used as sugar substitutes. The sweetness of sugar alcohols varies from 25% to about 90% as sweet as sugar. Sugar alcohols suitable for the present disclosure include but are not limited to sorbitol, xylitol, lactitol, isomalt, mannitol, erythritol, and maltitol. Sugar alcohols may also serve as a bulk filler.

Optional antioxidants include but are not limited to preservatives such as TBHQ, tocopherols, rosemary extract, and the like.

Optional whitening agents include but are not limited to titanium dioxide (TiO₂), calcium carbonate (CaCO₃), and starch. Starch may also serve as a bulk filler.

In some examples, the white chocolate confectionery product contains substantially all particles having a size of less than 60 microns, less than 50 microns, and in some other examples about 45 microns as measured by a micrometer for coatings and less than 40 microns or less than 30 microns for solid bars and novelty shapes.

The white chocolate confectionery products of the present disclosure include for example, candy bars/pieces, coated bars, and cookies/snacks, baking chocolate, chocolate chips, ice cream bars, refrigerated desserts, or other foods in which white chocolate confectionery product is an ingredient. In these foods, the white chocolate has the rheological flow properties associated with typical white chocolate confections containing normal levels of standard nutritive sugar content chocolate, but with at least one rare sugar, such as allulose. The preparation of a white chocolate confectionery product having a reduced sugar content using at least one rare sugar, such as allulose, was unexpectedly problematic due to thickening or gelling during processing and/or manufacturing and unstable viscosity. The present inventors found that such thickening or gelling and unstable viscosity is prevented or alleviated by employing a higher fat system, overdosing the chocolate with emulsifiers/surfactants, and/or reducing moisture levels to below 2.0 wt % to obtain a reduced sugar content white chocolate confectionery product having rheological properties suitable for pumping, enrobing, molding, or depositing.

To obtain and maintain desirable rheological and organoleptic properties of white chocolate confections and white chocolate confectionery products of the present disclosure can be prepared by mixing, refining, and conching processes. For example, white chocolate confections and white chocolate confectionery products of the present disclosure can be prepared by mixing a fat, a sweetener, and other dry bulk ingredients. The sweetener comprises at least one rare sugar or a combination of at least one rare sugar and at least one standard carbohydrate sugar, wherein the at least one rare sugar is selected from the group consisting of allulose, tagatose, allose, sorbose, apiose, ribose, L-rhamnose, L-fructose, D-mannose, trehalose, and kojibiose to obtain a mixture of fat/sweetener/other dry bulk ingredients; refining the fat/sweetener/other dry bulk ingredients mixture to obtain a particle size of 60 μm or less; conching the mixture, adding an emulsifier/surfactant to standardize the fat/sweetener/other dry bulk ingredients mixture. The white chocolate confection or white chocolate confectionery product has an apparent viscosity at 45° C. and 20 rpm (as measured by Brookfield viscometer) of 1,000 to 15,000 cp and a plastic viscosity and yield value at 45° C. of 500-10,000, or 600-10,000, or 1,000-10,000 cp and 1-150 dynes/cm², respectively, using the NCA/CMA Casson regression model.

Refining can be accomplished by roller refining, and/or milling. Refining breaks up crystalline sugar, other dry bulk ingredients, and milk solids such that the sizes of the particles are significantly reduced. This particle size reduction results in the desired smoothness of the chocolate. Roller refining generally refers to a process of refining or reducing particle size by grinding a mixture of the sweetener, other dry bulk ingredients, and a fat ingredient(s) in the form of a coarse paste using a conventional chocolate roll refiner comprising steel rollers to convert it into a refined flake. Any number of acceptable milling techniques can also be employed for the refining step. Ball milling is a size reduction technique that uses media in a rotating cylindrical chamber to mill materials to a fine powder. A Micropul ACM mill will reduce the particle size of sugar within the desired range with a reduction of ultrafines.

Methods for reducing particle size or refining the fat/sweetener/bulk paste, include but are not limited to roll refining or ball milling the fat/sweetener/bulk paste as shown. In the roll refining process, a predetermined amount of the fat ingredient (e.g., cocoa butter), other dry bulk ingredients, and sweetener comprising at least one rare sugar, such as allulose, are mixed in a batch mixer to form a fat/sweetener/bulk ingredients mixture. The fat/sweetener/bulk ingredients mixture is then passed through the nip of at least one pair of roll refiners (6,8) to produce a mixture having a particle size of about 60 μm or less.

In another embodiment, the mixture can be prepared by first refining the sweetener using a ball mill and then blending with the fat ingredient in a blender in accordance with procedures known in the skill of the art.

Conching follows refining. The term “conching” means a process in which a refined chocolate flake mixture is mixed at a predetermined temperature for a predetermined time period. The purposes of conching include promoting the even distribution of cocoa butter, removing moisture, and forming flowable chocolate paste. Typically, conching is performed at a temperature of at least 40° C. for a period of two to four hours. Preferably, conching is performed for two hours or less. Typically, the mixing comprises a scraping action that generates from friction at least some of the heat necessary to maintain the temperature.

In the conching step of the present disclosure, the fat/sweetener/other dry bulk ingredients mixture is stirred while heating to give the final desired consistency. Typical conching temperatures are in the range of 55° C. and above. However, in the examples of the present disclosure, conching is conducted at a predetermined temperature that is relatively lower than typical conching temperatures of the range of 55° C. and higher. In some examples of the present disclosure, the predetermined conching temperature is in the range of 50° C. or lower, or in the range of 40° C.-48ºC. In some examples of the disclosure, the conching temperature is less than 50° C. for a predetermined conching time. In some examples of the present disclosure, the predetermined conching time is within a range of 2.5-4 hours. The mixing/kneading process during conching allows moisture to escape while smoothing the chocolate paste and is critical smooth and creamy texture development of chocolate. Standardizing follows the conching step. Standardizing involves adding the remaining fat and/or emulsifiers/surfactants to reduce the apparent viscosity, plastic viscosity, and yield value to the desired levels effective for obtaining a chocolate confectionery product having the desired rheological properties.

Another problem encountered during the preparation of a white chocolate confectionery product having a reduced sugar content using at least one rare sugar, such as allulose, was that during conching hard chocolate grits, or agglomerates formed. The present inventors found that such agglomeration could be prevented, inhibited, alleviated, or significantly reduced such that substantially no agglomerates formed by conching at lower than normal conching temperatures for the duration of the conch, or conching at a lower temperature at least in an initial stage of conching. In some examples of the disclosure, the predetermined conching time period is within a range of 2.0-4 hours, and the conching temperature of less than 50° C. is maintained for the entire conching time period. In some examples of the disclosure, the predetermined conching temperature is in the range of 40-48° C. and the conching temperature of 40-48° C. is maintained for the entire conching time. In other examples of the present disclosure, conching comprises at least an initial stage at a conching temperature of 50° C. or less, and further comprises a second stage, wherein the conching temperature is greater than 50° C. in the second stage. In some other examples conching comprises at least an initial stage at a conching temperature of 40-48° C., and further comprises a second stage, wherein the conching temperature is greater than 50° C. in the second stage.

Yet another problem encountered during storage of a white chocolate confectionery product having a reduced sugar content using at least one rare sugar, such as allulose, was that the reduced sugar content white chocolate had a noticeable and undesirable color change. The present inventors found that such an undesirable color change could be prevented, inhibited, or alleviated by adding a whitening agent to the chocolate or employing an ingredient of a minimal amount of protein.

The color is measured by X-Rite Colori5 Spectrophotometer where L, a, and b values as defined by the International Commission on Illumination (abbreviated CIE) were obtained. The amount of change in visual perception of two colors is measured by Delta E (ΔE) which is calculated by the below equation:

$$Δ {E}_{ab}^{*} = \sqrt{{( {L}_{2}^{*} - {L}_{1}^{*} )}^{2} + {( {a}_{2}^{*} - {a}_{1}^{*} )}^{2} + {( {b}_{2}^{*} - {b}_{1}^{*} )}^{2}} ;$$

wherein Delta E (ΔE) is the color difference between the white chocolate paste samples at time 0 and at time n weeks (n=1, 2, 3, and 4), and Samples: L*₀, a*₀, b*₀ at time 0 and Samples L*ₙ, a*ₙ, b*ₙ at ‘n’ weeks;
L* denotes lightness of the color (L=0 indicates black, and L=100 indicates diffused White).
a* refers to red-green range; negative values indicate green and positive values indicate red; and
b* refers to the blue-green range; negative values indicate blue and positive values indicate yellow.

The chocolates of the present disclosure can be used in a solid bar in which the entire bar is made up of solely chocolate. The solid bar is preferably a geometrical shape, for example, a circle, a rectangle, or a square.

The white chocolate confectionery products of the present disclosure can additionally be used as a coating. As used herein, the term “coating” refers to a food which is covered or enveloped with chocolate. Various foods which may be coated include fruits (e.g., cherries, strawberries, bananas, and the like), marshmallow, cake, cookies, toffee, peanut butter, caramel, nuts, raisins, nougat, baked goods, ice cream bars, candy bars, puddings, creams, and the like.

Apart from being used in a solid bar and as a coating, the chocolates of the present disclosure can also be used in making novelty shapes as previously defined.

The white chocolate confectionery product having a reduced sugar content due to the incorporation of at least one rare sugar in the sweetener and made according to the process of the present disclosure, has desirable flow properties and stabilized rheology for at least 24 hours to a month at elevated temperatures. Because of the unique composition and method, the chocolate of the present disclosure meets flow requirements for pumping, molding, and enrobing.

### EXAMPLES

Reduced sugar white chocolate confections of the present disclosure are further described in the context of the following examples, which are presented by way of illustration, but are not intended to limit the invention.

### Example 1

### White Chocolate with Sugar (Standard Nutritive Carbohydrate Sweetener)

A typical white chocolate was made by a traditional mix/refine/conche method with typical ingredients shown in Table 1. The mixture was refined using a Buhler 300 mm laboratory scale roll refiner. The batch was refined to a 25-30-micron particle size (handheld micrometer) at about 27.6% refined fat. The resulting refined material was split into six equal batches. Each batch was conched in an eight-quart Globe orbital mixer with mixer speed set at 1. The water bath was set for 50° C. The batches were conched for at least 2.5 hours. At the start of the conche cycles, the balance of the fats was added. Thirty minutes before the end of the conche, the surfactants were added. Samples were then stored at 45° C. or 50° C. No rheology change and discoloration were noticed.

TABLE 1

| Ingredients | % |
|---|---|
| Sugar | 36.0 |
| Milk, Non-Fat Powder | 17.7 |
| CBE | 26.5 |
| Milk fat | 4.0 |
| Corn Syrup Solids | 11.0 |
| Lactose | 4.5 |
| Vanilla flavor | 0.03 |
| Lecithin, Soy | 0.3 |
| PGPR | 0.02 |
| Total | 100.0 |
| Total fat | 31.0 |
| Total sugar | 50.0 |

### Example 2

### Unstable White Chocolate with 25% Sugar Reduction by Replacing Sugar with Allulose-Thickening/Gelling

A reduced sugar white chocolate was made by a typical mix/refine/conch process as in Example 1, with the ingredients shown in Table 2, wherein the sugar content was reduced by 25% by replacing the sugar with allulose. The mixture was refined using a Buhler 300 mm laboratory scale roll refiner to a 20-25-micron particle size (handheld micrometer) at about 27.6% refined fat, and then conched under controlled temperature of 50° C. for 2.5 hours. The mixture was then standardized with emulsifiers and the remaining fats.

TABLE 2

| Ingredients | % |
|---|---|
| Sugar | 28.2 |
| Allulose | 13.0 |
| Cream Powder | 2.1 |
| Rice starch | 6.5 |
| Lactose | 9.3 |
| Vegetable oil blend | 32.7 |
| Corn Syrup Solids | 7.5 |
| Vanilla flavor | 0.03 |
| Lecithin, Soy | 0.4 |
| PGPR | 0.30 |
| Total | 100.0 |
| Total fat | 35.0 |
| Total sugar | 38.0 |
| Sugar reduction | 25.0 |
| Total protein, % | 0.4 |

The initial paste was very thin, and had an apparent viscosity of 2600 cp, a plastic viscosity of 2083 cp, and a yield value of 5.02 dynes/cm². However, the white chocolate wherein the sugar content was reduced by 25% by replacing the sugar with allulose turned into an unflowable, thick, viscous, gel after storage at 45° C. or 50° C. for about 1 week without agitation such that a spatula could stand up in the unflowable gel as shown in FIG. 1. When the spatula was removed a hole was left in the unflowable white chocolate gel as can be seen in FIG. 1B.

The finished white chocolate of Example 2 had a moisture content of 1.58% by weight, and a water activity (AW) of about 0.24.

Additionally, the white chocolate of Example 2 exhibited a slightly noticeable color change at about day 9 of storage at 45° C. with a ΔE value of about 3.8.

### Example 3

### Stable White Chocolate Confection with 25% Sugar Reduction by Replacing Sugar with Allulose—No Gelling

A reduced sugar white chocolate was made by a typical mix/refine/conche process as in Example 1, with the ingredients shown in Table 3, wherein the sugar content was reduced by 25% by replacing a portion of the sugar with 13.0% allulose. The mixture was refined using a Buhler 300 mm laboratory scale roll refiner to about 23-micron particle size (handheld micrometer) at about 27.6% refined fat, and then conched under controlled temperature of 50° C. for 2.5 hours. The mixture was then standardized with emulsifiers and the remaining fats.

TABLE 3

| Ingredients | % |
|---|---|
| Sugar | 28.0 |
| Allulose | 13.0 |
| Cream Powder | 2.1 |
| Rice starch | 6.5 |
| Lactose | 9.4 |
| Vegetable oil blend | 32.5 |
| Corn Syrup Solids | 7.6 |
| Vanilla flavor | 0.03 |
| Lecithin, Soy | 0.60 |
| PGPR | 0.30 |
| Total | 100.0 |
| Total fat | 35.0 |
| Total sugar | 38.0 |
| Sugar reduction of 51% original | 25.0 |
| formula | |
| Total protein | 0.4 |

The initial paste had an apparent viscosity of 3350 cp, a plastic viscosity of 1083 cp, and a yield value of 32.8 dynes/cm².

The finished white chocolate confection had a moisture of 1.26% by weight and a water activity (AW) of about 0.23.

The white chocolate confection wherein the sugar content was reduced by 25% by replacing a portion of the sugar with 13.03% allulose and employing lecithin in an amount of 0.6% and PGPR in an amount of 0.3% remained in a flowable state after storage for more than 2 weeks at 50° C. or more than 4 weeks at 45° C. and had apparent viscosity of 4300 cp, plastic viscosity of 990 cp and a yield value of 56.3 dynes/cm². at 50° C. at 17 days, or apparent viscosity of 3900 cp, plastic viscosity of 1125 cp, and yield value of 41.3 dynescm² at 45° C. at 4 weeks.

Additionally, the white chocolate confection of Example 3 had nearly unnoticeable color changes (i.e., browning or Maillard reaction) with a ΔE value of 2.7 at 50 at 17 days, and a ΔE value of 2.1 at 45° C. at 4 weeks.

### Example 4

### Unstable Zero Sugar White Chocolate Confection with Allulose Sweetener—Grits Forming and Thickening/Gelling

A reduced sugar content white chocolate confection was made by a typical mix/refine/conche process as in Example 1, with the ingredients shown in Table 4, with zero sugar content and 25% allulose as the only sweetener. The mixture was refined using a Buhler 300 mm laboratory scale roll refiner to about 25-micron particle size (handheld micrometer) at about 29.0% refined fat, and then conched under controlled temperature of 50° C. for 4.0 hours. The mixture was then standardized with emulsifiers and the remaining fats.

TABLE 4

| Ingredients | % |
|---|---|
| Soluble Corn Fiber | 24.1 |
| Micro crystalline cellulose | 2.6 |
| Allulose | 25.0 |
| Vegetable oil blend | 27.8 |
| Rice flour | 7.6 |
| Rice starch | 3.7 |
| Cream Powder | 7.0 |
| Butter Flavor | 1.4 |
| Lecithin, soy | 0.4 |
| PGPR | 0.3 |
| Stevia | 0.07 |
| Vanilla flavor | 0.03 |
| Total | 100.00 |
| Total Fat | 33.7 |
| Total Protein | 1.7 |

During conching at 50° C., it was noticed that some hard chocolate grits, i.e., agglomerates, formed.

The initial paste had an apparent viscosity of 2600 cp, a plastic viscosity of 3006 cp, and a yield value of 0.432 dynes/cm².

The finished white chocolate had a moisture content of 2.0% by weight and a water activity (AW) of about 0.17.

The white chocolate confection with 25% allulose as the only sweetener employing lecithin in an amount of about 0.4% and PGPR in an amount of about 0.3% tuned into an unflowable, thick, viscous gel after storage for 1 week at 50° C., but remained in a flowable state after storage for 4 weeks at 45° C. Additionally, the white chocolate of Example 4 exhibited noticeable color changes (i.e., browning, Maillard reaction) with a ΔE value of 5.3 at 50° at 2 weeks, and a ΔE value of 4.9 at 45° C. at 4 weeks.

### Example 5

### Stable Zero Sugar White Chocolate Confection with Allulose Sweetener—No Gelling

A reduced sugar content white chocolate confection was made by a typical mix/refine/conche process as in Example 1, with the ingredients shown in Table 5, with zero sugar content and 25% allulose as the only sweetener. The mixture was refined using a Buhler 300 mm laboratory scale roll refiner to about 28-micron particle size (handheld micrometer) at about 28.4% refined fat, and then conched under a controlled temperature of 45-48° C. for 3.5 hours. The mixture was then standardized with emulsifiers and the remaining fats.

TABLE 5

| Ingredients | % |
|---|---|
| Soluble corn Fiber | 24.0 |
| Micro crystalline cellulose | 3.6 |
| Allulose | 25.0 |
| Vegetable oil blend | 28.7 |
| Rice flour | 4.3 |
| Rice starch | 7.0 |
| Cream Powder | 3.0 |
| Butter flavor | 1.4 |
| Milk fat | 2.0 |
| Lecithin, soy | 0.65 |
| PGPR | 0.25 |
| Stevia | 0.08 |
| Vanilla flavor | 0.02 |
| Total | 100.0 |
| Percent Fat | 34.0 |
| Total protein | 0.8 |

During conching at a temperature in the range of 45-48° C., which is lower than typical conching temperatures, it was noticed that hard chocolate grits, i.e., agglomerates, did not form.

The initial paste had an apparent viscosity of 1350 cp, a plastic viscosity of 1105 cp, and a yield value of 0.71 dynes/cm². The white chocolate with 25% allulose as the only sweetener employing lecithin in an amount of about 0.65% and PGPR in an amount of about 0.25% remained in a flowable state after storage for 2 weeks at 50° C., or after storage for 4 weeks at 45° C., with an apparent viscosity of 1800 cp, plastic viscosity 679 cp, and a yield value of 13.3 dynes/cm² after storage at 2 weeks at 50° C.; and apparent viscosity of 1750 cp, plastic viscosity of 819 cp, and a yield value of 9.3 dynes/cm² after storage at 45° C. at 4 weeks. The finished white chocolate had a moisture content of 1.5% by weight, and a water activity (AW) of about 0.09.

Additionally, the white chocolate of Example 5 exhibited a minimal noticeable color change (i.e., browning, Maillard reaction) with a ΔE value of 3.2 at 50° at 2 weeks, and a ΔE value of 3.3 at 45° C. at 4 weeks.

### Example 6

### Zero Sugar White Chocolate Confection with Allulose Sweetener Using a Ball Mill

A zero sugar content white chocolate with the same formula as that in Example 5 shown in Table 6, was made using ball milling instead of roller refining and wet conched.

TABLE 6

| Ingredients | % |
|---|---|
| Soluble corn Fiber | 24.1 |
| Micro crystalline cellulose | 3.60 |
| Allulose | 25.0 |
| Vegetable oil blend | 28.7 |
| Rice flour | 4.3 |
| Rice starch | 7.0 |
| Cream Powder | 3.0 |
| Butter flavor | 1.3 |
| Milk fat | 2.0 |
| Lecithin, soy | 0.65 |
| PGPR | 0.25 |
| Stevia | 0.08 |
| Vanilla flavor | 0.02 |
| Total | 100.0 |
| Percent Fat | 34.0 |
| Total protein | 0.8 |

A four kilogram batch of white chocolate was made. All ingredients except PGPR were weighed into a Hobart mixer and mixed until uniform. The mixture at about 28.4% refined fat, was transferred into the ball mill to refine using a CaoTech ball mill at media to material ratio of about 6.8:1. The media size was about 6.4 mm. A water bath was connected to the ball mill with a temperature setting at 100° F.-108° F. (37.8° C.-42° C.) to control refining temperature at <120° F. (49° C.). At about 1 hour of refining, about 9.7 gm of PGPR was added. Refining was continued for 1 hour the remaining PGPR and vanillin were added, and refining was continued for another 15 minutes, for a total refining time of 2 hours and 15 minutes. The chocolate had a particle size of about 26 microns. 1100 gm of the paste was discharged into a HOBART® mixer, and wet conched for 3.5 hours at 122° F. (50° C.) to remove moisture. The conched chocolate was stable without gelling after storage at 45° C. for 4 weeks, or at 50° C. for 2 weeks.

The remaining chocolate in the ball mill which was not wet conched was discharged and stored under the same conditions (45° C. for 4 weeks or 50° C. for 2 weeks). The chocolate formed an unflowable gel and exhibited significant color change (i.e., browning or Maillard reaction). A summary of the results is provided in Table 7 below.

TABLE 7

| | | | | Yield |
|---|---|---|---|---|
| | Moisture, | APV @20 | PV, | Value, |
| | wt % | rpm, cp | cp | dynes/cm² |
| Ball milled, 0-time | 2.47 | 5100 | 1795 | 42.9 |
| Ball milled + wet | 2 | 3800 | 2080 | 14.4 |
| conch, 0-time | | | | |
| Ball milled without | 2.22 | gelled | | |
| conch, stored at | | | | |
| 45° C./4 weeks | | | | |
| Ball milled with conch, | 1.85 | 3400 | 2349 | 6.16 |
| stored at 45° C./4 weeks | | | | |

Essentially adding the conching step after ball milling decreased the moisture content of the paste from about 2.47% by weight to about 2.00% by weight and made the chocolate stable again with minimum color changes.

### Mitigation of Color Change in Allulose-Containing White Chocolate

### Example 7

Allulose-containing white chocolate confections were made having the ingredients set forth in Table 8 below. Crème powder in the control formula, which contains protein source, was replaced with (1a) polydextrose; (1b) polydextrose/CaCO₃ (1/1) and (1c) CaCO₃. In another experiment, a small amount of (1d) TiO₂ (0.5%) was added to the control formula to negate or mask the brown color formation due to Maillard Reactions.

TABLE 8

| Control | | Polydextrose -1a | | Polydextrose/CaCO₃-1b | | Calcium carbonate -1c | | TiO₂ - 1d | |
|---|---|---|---|---|---|---|---|---|---|
| Corn Fiber | 24.2% | Corn Fiber | 24.2% | Corn Fiber | 24.2% | Corn Fiber | 24.2% | Corn Fiber | 24.2% |
| Allulose | 25.0% | Allulose | 25.0% | Allulose | 25.0% | Allulose | 25.0% | TiO2 | 0.5% |
| Vegetable | 27.7% | Vegetable | 27.7% | Vegetable | 27.7% | Vegetable | 27.7% | Allulose | 25.0% |
| oil blend | | oil blend | | oil blend | | oil blend | | | |
| Rice starch | 14.1% | Rice starch | 14.1% | Rice starch | 14.1% | Rice starch | 14.1% | Vegetable | 27.7% |
| | | | | | | | | oil blend | |
| Cream Powder | 7.0% | Polydextrose | 7.0% | Polydextrose | 3.5% | CaCO3 | 7.0% | Rice starch | 13.6% |
| Butter flavor | 1.3% | Butter flavor | 1.3% | CaCO3 | 3.5% | Butter | 1.3% | Cream | 7.0% |
| | | | | | | flavor | | Powder | |
| Lecithin | 0.42% | Lecithin | 0.42% | Butter flavor | 1.3% | Lecithin | 0.42% | Butter flavor | 1.3% |
| PGPR | 0.28% | PGPR | 0.28% | Lecithin | 0.42% | PGPR | 0.28% | Lecithin | 0.42% |
| Vanilla flavor | 0.03% | Vanilla flavor | 0.03% | PGPR | 0.28% | Total | 100.0% | PGPR | 0.28% |
| Total | 100.0% | Total | 100.0% | Total | 100.0% | | | Vanilla flavor | 0.03% |
| | | | | | | | | Total | 100.0% |

The white chocolate was refined using a BUHLER® 300 mm laboratory scale roll refiner to about 30-micron particle size (handheld micrometer) and then conched under controlled temperature of 50° C. for 3.5 hours. The mixture was then standardized with emulsifiers and the remaining fats. The white chocolate was stored at 45° C. for 4 weeks. The color was measured at time 0, week 1, 2, 3 and 4 for all pastes. Fat, moisture, protein, allulose content, and water activity were measured at time 0 and at the end of 4 weeks.

The L*a*b* color values were obtained using X-Rite Colori5 Spectrophotometer on the samples as shown below in Table 9. Table 9 also provides the average values L*a*b* and Delta E calculated according to the formula below:

$$Δ E = \sqrt{{( {L}_{0}^{*} - {L}_{n}^{*} )}^{2} + {( {a}_{0}^{*} - {a}_{n}^{*} )}^{2} + {( {b}_{0}^{*} - {b}_{n}^{*} )}^{2}} .$$

Delta E (ΔE)—color difference between the white chocolate paste samples at time 0 and at time n weeks (n=1, 2, 3, and 4). L*₀, a*₀, b*₀—Samples at time 0; L*ₙ, a*ₙ, b*ₙ—Samples at ‘n’ weeks.

L*—lightness of the color (L=0 indicate black and L=100 indicate diffused White).

TABLE 9

| | | | | | | | | | moisture | Allulose | | protein |
|---|---|---|---|---|---|---|---|---|---|---|---|---|
| Formula | Batch # | Weeks | Temp | L* | a* | b* | Delta E | Fat % | % | % | Aw | % |
| Control | Batch 1 | 0 | 23 | 84.47 | −1.36 | 17.82 | 0.00 | 33.97 | 2.14 | 23.90 | 0.24 | 1.24 |
| | Batch 1 | 1 | 45 | 83.47 | −0.47 | 19.71 | 2.32 | | | | | |
| | Batch 1 | 2 | 45 | 82.13 | 0.48 | 21.77 | 4.95 | | | | | |
| | Batch 1 | 3 | 45 | 81.65 | 0.77 | 23.35 | 6.56 | | | | | |
| | Batch 1 | 4 | 45 | 81.41 | 1.05 | 22.59 | 6.16 | 32.38 | 2.15 | 22.90 | 0.22 | 1.26 |
| 1a | Batch 2 | 0 | 23 | 84.91 | −1.81 | 18.05 | 0.00 | 28.72 | 2.63 | 23.60 | 0.19 | 0.21 |
| | Batch 2 | 1 | 45 | 84.01 | −1.22 | 19.38 | 1.71 | | | | | |
| | Batch 2 | 2 | 45 | 83.42 | −0.87 | 20.27 | 2.83 | | | | | |
| | Batch 2 | 3 | 45 | 83.37 | −0.81 | 20.30 | 2.90 | | | | | |
| | Batch 2 | 4 | 45 | 83.44 | −0.67 | 20.06 | 2.74 | 27.01 | 2.36 | 23.20 | 0.22 | 0.28 |
| 1b | Batch 8 | 0 | 45 | 84.88 | −1.62 | 13.83 | 0.00 | 28.70 | 2.36 | 23.90 | 0.20 | 0.22 |
| | Batch 8 | 1 | 45 | 84.79 | −1.59 | 14.16 | 0.34 | | | | | |
| | Batch 8 | 2 | 45 | 84.61 | −1.60 | 13.89 | 0.28 | | | | | |
| | Batch 8 | 3 | 45 | 84.63 | −1.58 | 14.00 | 0.30 | | | | | |
| | Batch 8 | 4 | 45 | 84.43 | −1.56 | 14.06 | 0.51 | 28.19 | 2.11 | 21.70 | 0.26 | 0.23 |
| 1c | Batch 7 | 0 | 45 | 84.71 | −1.53 | 11.99 | 0.00 | 28.90 | 2.32 | 24.00 | 0.22 | 0.18 |
| | Batch 7 | 1 | 45 | 84.52 | −1.54 | 12.16 | 0.26 | | | | | |
| | Batch 7 | 2 | 45 | 84.40 | −1.56 | 12.04 | 0.32 | | | | | |
| | Batch 7 | 3 | 45 | 84.45 | −1.61 | 12.00 | 0.27 | | | | | |
| | Batch 7 | 4 | 45 | 84.45 | −1.56 | 12.10 | 0.28 | 29.73 | 1.99 | 24.00 | 0.26 | 0.18 |
| 1d | Batch 5 | 0 | 23 | 86.20 | −1.14 | 9.14 | 0.00 | 34.05 | 2.47 | 24.00 | 0.21 | 1.22 |
| | Batch 5 | 1 | 45 | 85.53 | −0.78 | 10.57 | 1.62 | | | | | |
| | Batch 5 | 2 | 45 | 85.19 | −0.49 | 11.50 | 2.65 | | | | | |
| | Batch 5 | 3 | 45 | 84.84 | −0.27 | 12.34 | 3.58 | | | | | |
| | Batch 5 | 4 | 45 | 84.92 | −0.19 | 12.37 | 3.60 | 32.73 | 2.43 | 23.80 | 0.22 | 1.23 |

Color data (L*, a* & b*) and Delta E (ΔE) values at weeks 0 through 4. Moisture %, fat % and allulose %, Aw (water activity) and protein % were collected at the start (week 0) and at the end of storage (week 4) at 45° C.
a* - where negative values indicate green and positive values indicate red
b* - where negative values indicate blue and positive values indicate yellow

The control sample showed the most browning color change difference during storage at 45° C. as expected compared to other variants as shown by color data and Delta E (ΔE) value. The Maillard Reactions (MR) between protein present in crème powder and allulose are primarily responsible for the color formation. Replacing crème powder in the control formula with polydextrose (1a) resulted in lowering of browning, but those samples still exhibited significant color formation. Substituting half of the amount of polydextrose with CaCO₃ (1b) resulted in minimal color formation as evidenced by Delta E (ΔE) values. Similarly, sample (1c) (full substitution with CaCO₃) also resulted in a reduction in color formation compared to sample (1a). Also, introducing a small amount of TiO₂ (1d) as a whitening agent to the control sample resulted in masking of the browning of due to MR. The (1d) white paste had L*, b*color values like the (1b) & (1c) pastes but the a* values were significantly different. Table 10 below shows a color comparison between the Control and Variant Samples (1a), (1b), (1c), and (1d).

TABLE 10

Delta E

| | Week 0 | Week 4 |
|---|---|---|
| Control vs 1a | 0.67 | 3.67 |
| Control vs 1b | 4.02 | 9.42 |
| Control vs 1c | 5.84 | 11.23 |
| Control vs 1d | 8.88 | 10.88 |

Delta E in Table 10 was calculated according to the formula below between control (L*_{c}, a*_{c}, b*_{c}) and variant samples (L*ₙ, a*ₙ, b*ₙ) 1a, 1b and 1c at week 0 and week 4.

$$Δ E = \sqrt{{( {L}_{c}^{*} - {L}_{n}^{*} )}^{2} + {( {a}_{c}^{*} - {a}_{n}^{*} )}^{2} + {( {b}_{c}^{*} - {b}_{n}^{*} )}^{2}} .$$

The color comparison data in Table 10 between control and the Variant Samples at the end of storage (week 4) shows that all variants exhibited significantly less browning. It is noteworthy that white paste samples (1b) and (1c) exhibited the least change in color during storage. There was a strong correlation of color values with protein % but no correlation of color data with moisture %, fat % allulose %, and Aw (water activity) were established.

### Example 8

### Increasing Fat Content in an Allulose Containing Confection to Reduce Viscosity in Storage at 50° C.

Six 2-kilogram batches of chocolate were made based on the following refining Allulose White Chocolate Formula in Table 11 below:

TABLE 11
Allulose Model Chocolate Formula

| | |
|---|---|
| Allulose | 57.00 |
| Cocoa Butter | 23.00 |
| NFMS | 20.00 |
| Total | 100.00 |

Ingredients were blended at 24.5% fat in 20-quart Globe mixers until a dough-like consistency was achieved and then were held in a 50° C. heated cabinet until refined. Mixtures were refined on a Buhler 300 mm roll refiner at 45° C. to a particle size of roughly 20-25 microns as measured by handheld micrometer. Refined flake was placed directly back on the mixer. Mixtures were then conched at 24.5% fat in 8-quart Globe mixers set to speed 1 with 50° C. water baths. Batches were standardized at three and a half hours to the final fat levels and taken off the conche at roughly four hours.

Each batch was standardized with 0.3% lecithin and 0.1% PGPR. Table 12 below indicates the additional cocoa butter and milk fat added during standardizing, as a percentage of the total mass.

TABLE 12

| Final Fat | AMF | Cocoa |
|---|---|---|
| (%) | (%) | Butter (%) |
| 29 | 5.5 | 0 |
| 31 | 6.0 | 2.2 |
| 33 | 6.3 | 4.6 |
| 35 | 6.7 | 6.8 |
| 37 | 7.1 | 9.1 |
| 39 | 7.5 | 11.3 |

Viscosity was measured initially and after 4 weeks of storage at 50° C. The results are shown in Table 13 below, indicating that about 37% fat is needed in order to obtain a stable allulose containing chocolate confectionery product in 50° C. storage for up to 4 weeks.

TABLE 13

| | Initial | | | After Hold (4 weeks) | | |
|---|---|---|---|---|---|---|
| | | | YV | | | YV |
| Fat % | AV (cP) | PV (cP) | (Dy/cm²) | AV (cP) | PV (cP) | (Dy/cm²) |
| 29 | 8563 | 4088 | 42.6 | 25130 | 19003 | 25.8 |
| 31 | 6750 | 3414 | 30.2 | 17750 | 13260 | 19.0 |
| 33 | 6650 | 3375 | 28.7 | 14190 | 9844 | 21.1 |
| 35 | 3325 | 1572 | 16.6 | 11250 | 7363 | 22.6 |
| 37 | 3800 | 2039 | 14.4 | 8100 | 3749 | 43.1 |
| 39 | 3675 | 2149 | 11.1 | 5500 | 3356 | 14.8 |

Further, the disclosure comprises additional notes and examples as detailed below.

Clause 1. A white chocolate confectionery product having a reduced sugar content comprising:
a fat ingredient,
a sweetener comprising at least one rare sugar, or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, D-mannose, trehalose,
and kojibiose,
an emulsifier/surfactant; and
an optional dairy ingredient, bulk filler, intense sweetener, whitening agent, and/or flavor,
wherein the white chocolate confectionery product has a stable apparent viscosity at 40° C. and 20 rpm (as measured by Brookfield viscometer) of 1,000 to 15,000 cp; a stable plastic viscosity at 40° C. using the NCA/CMA Casson regression model of 500 to 10,000 cp, and stable yield value at 40° C. using the NCA/CMA Casson regression model of 0.5-150 dynes/cm².

Clause 2. The white chocolate confectionery product according to claim 1, wherein the apparent viscosity, plastic viscosity, and yield value are stable at temperatures of from above 100° F. (38° C.) for at least two weeks.

Clause 3. The white chocolate confectionery product according to clause 1, wherein the apparent viscosity, plastic viscosity, and yield value are stable at temperatures of from about 100° F. (38° C.) to about 122° F. (50° C.) for at least two weeks.

Clause 4. The white chocolate confectionery product according to clause 1, wherein the apparent viscosity, plastic viscosity, and yield value are stable at a temperature of from above 100° F. (38° C.) to about 113° F. (45° C.) for up to 4 weeks.

Clause 5. The white chocolate confectionery product according to any one of clauses 1-4, wherein there is substantially no discoloration at elevated storage temperatures from above 38° C. for at least one week as measured by ΔE≤3.0.

Clause 6. The white chocolate confectionery product according to any one of claims 1-5, wherein the at least one rare sugar comprises allulose.

Clause 7. The white chocolate confectionery product according to any one of clauses 1-6, having a fat content of about ≥30% by weight.

Clause 8. The white chocolate confectionery product according to any one of claims 1-7, having a moisture content of less than about 2.0% by weight.

Clause 9. The white chocolate confectionery product according to any one of clauses 1-8, having an emulsifier/surfactant content of about 0.5% to about 0.9% by weight.

Clause 10. The white chocolate confectionery product according to any one of clauses 1-8, wherein the emulsifier/surfactant comprises a combination of lecithin and PGPR, said combination having a content of lecithin of about 0.3% to about 0.6 by weight, and a content of PGPR of about 0.1% to about 0.3% by weight.

Clause 11. The white chocolate confectionery product according to any one of clauses 1-8, wherein the emulsifier/surfactant comprises a combination of lecithin and PGPR, said combination having a content of about 0.6% lecithin by weight and about 0.3% PGPR by weight, and the confectionery product having a moisture content of about 1.2% to about 2.0% by weight.

Clause 12. The white chocolate confectionery product according to any one of clauses 1-11, comprising a bulk filler, wherein the bulk filler is selected from the group consisting of flour, starch, fiber, polydextrose, fructooligosaccharides, inulin, dextrin, sugar alcohols, and combinations or mixtures thereof.

Clause 13. The white chocolate confectionery product according to clause 12, wherein the bulk filler comprises a protein content of less than 20.0% by weight.

Clause 14. The white chocolate confectionery product according to any one of clauses 1-13, comprising a protein content of less than 1.0%.

Clause 15. The white chocolate confectionery product according to any one of clauses 1-14, further comprising a whitening agent.

Clause 16. The white chocolate confectionery product according to any one of clauses 1-5 and 7-12, wherein the rare sugar comprises tagatose, and wherein the bulk filler comprises a protein content of less than 20.0% by weight.

Clause 17. The white chocolate confectionery product according to clause 16, wherein the protein content of the white chocolate confectionery product is less than 1.0%.

Clause 18. A method for making a white chocolate confectionery product having a reduced sugar content, the method comprising:

mixing a predetermined amount of a fat ingredient and a predetermined amount of sweetener comprising at least one rare sugar or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, and D-mannose, and other dry bulk ingredients to obtain a fat/sweetener/bulk mixture;
refining the fat/sweetener/bulk mixture to obtain a particle size of <60 μm;
adding a predetermined amount of emulsifier/surfactant to the fat/sweetener/bulk mixture;
conching at a conching temperature of less than 50° C. for a predetermined conching time; and
standardizing with remaining emulsifiers/surfactants and fats.
wherein the white chocolate confectionery product has a stable apparent viscosity at 40° C. and 20 rpm (as measured by Brookfield viscometer) of 1,000 to 15,000 cp, a stable plastic viscosity at 40° C. using the NCA/CMA Casson regression model of 500 to 10,000 cp, and stable yield value at 40° C. using the NCA/CMA Casson regression model of 0.5-150 dynes/cm².

Clause 19. The method according to clause 18, wherein the apparent viscosity, plastic viscosity, and yield value are stable at temperatures of from above 100° F. (38° C.) for at least two weeks.

Clause 20. The method according to clause 18 or 19, wherein the apparent viscosity, plastic viscosity, and yield value are stable at temperatures of from about 100° F. (38° C.) to about 122° F. (50° C.) for at least two weeks.

Clause 21. The method according to any one of clauses 18-20, wherein the apparent viscosity, plastic viscosity, and yield value are stable at a temperature of from above 100° F. (38° C.) to about 113° F. (45° C.) for up to 4 weeks.

Clause 22. The method according to any one of clauses 18-21, wherein the at least one rare sugar comprises allulose.

Clause 23. The method according to any one of clauses 18-22, wherein refining comprises roll refining, ball milling, or combinations thereof.

Clause 24. The method according to any one of clauses 18-23, wherein a conching duration is an entire conching time within a range of 2.5-4.0 hours.

Clause 25. The method of any one of clauses 18-24, wherein the predetermined conching temperature is in the range of 40-48° C. conching.

Clause 26. The method according to any one of clauses 18-24, wherein conching is conducted in at least an initial stage and a second stage over a period within a range of 2.5-4 hours, and the predetermined conching temperature is 50° C. or less in the initial stage and >50° C. in the second stage.

Clause 27. The method of clause 26, wherein the predetermined conching temperature in the initial stage is in the range of 40-48° C.

Clause 28. The method according to any one of clauses 18-27, wherein a fat content is about ≥30% by weight.

Clause 29. The method according to any one of clauses 18-27, wherein a moisture content is less than about 2.0% by weight.

Clause 30. The method according to any one of clauses 18-29, wherein an emulsifier/surfactant content is from about 0.5% to about 0.9% by weight.

Clause 31. The method according to any one of clauses 18-30, wherein the emulsifier/surfactant comprises a combination of lecithin and PGPR, said combination having a content of lecithin of about 0.3% to about 0.6% by weight, and a content of PGPR of about 0.2% to about 0.3% by weight.

Clause 32. The method according to any one of clauses 18-29, wherein the emulsifier/surfactant comprises a combination of lecithin and PGPR, said combination having a content of about 0.6% lecithin by weight and about 0.3% PGPR by weight, and the confectionery product having a moisture content of about 1.5% to about 2.0% by weight.

Clause 33. The method according to any one of clauses 18-32, wherein the refining comprises ball milling and the method further comprises an additional conching step at a predetermined temperature for a predetermined time to reduce moisture to less than about 2.0% by weight.

Clause 34. The method according to any one of clauses 18-32, further comprising adding a whitening agent or a bulk filler which comprises a protein content of less than 20.0% by weight.

Clause 35. The method according to clause 34, comprising adding a bulk filler, wherein the protein content of the white chocolate confectionery product is less than 1.0%.

Clause 36. The method according to any one of clauses 18-34, wherein there is substantially no discoloration at elevated storage temperatures from above 40° C. for at least one week as measured by ΔE≤3.0.

Clause 37. The method according to clause 26, wherein no agglomerates are formed.

Clause 38. The method according to any one of clauses 18-24 and 22-37, wherein the rare sugar comprises tagatose, said method further comprising adding a whitening agent or a bulk filler which comprises a protein content of less than 20.0% by weight.

Clause 39. The method according to clause 38, comprising adding a bulk filler wherein the protein content of the white chocolate confectionery product is less than 1.0%.

Clause 40. The method according to clause 39, wherein there is substantially no discoloration at elevated storage temperatures from above 40° C. for at least one week as measured by ΔE≤3.0.

Clause 41. A method of preventing or inhibiting thickening of white chocolate which comprises a sweetener comprising at least one rare sugar or a combination of at least one rare sugar and at least one standard nutritive carbohydrate sugar, said method comprising:
conching at a temperature of less than 50° C. for a predetermined time; adding fat in an amount of about 30% by weight or more, overdosing the
white chocolate with an emulsifier/surfactant, and/or adjusting total moisture of the white chocolate to below 2.0%, wherein the at least one rare sugar is selected from the group consisting of allulose, tagatose, allose, sorbose, apiose, ribose, L-rhamnose, L-fructose, D-mannose, trehalose, and kojibiose; and
wherein the white chocolate confection has a stable apparent viscosity at 40° C. and 20 rpm (as measured by Brookfield viscometer) of 1,000 to 15,0000 cp, stable plastic viscosity at 40° C. using the NCA/CMA Casson regression model of 500 to 10,000 cp, and stable yield value at 40° C. using the NCA/CMA Casson regression model of 1-150 dynes/cm².

Clause 42. The method according to clause 41, wherein the apparent viscosity, plastic viscosity, and yield value are stable at temperatures of from above 100° F. (38° C.) for at least two weeks.

Clause 43. The method according to clause 41 or 42, wherein the apparent viscosity, plastic viscosity, and yield value are stable at temperatures of from about 100° F. (38° C.) to about 122° F. (50° C.) for at least two weeks.

Clause 44. The method according to any one of clauses 41-43, wherein the apparent viscosity, plastic viscosity, and yield value are stable at a temperature of from above 100° F. (38° C.) to about 113° F. (45° C.) for up to 4 weeks.

Clause 45. The method according to any one of clauses 41-44, wherein the rare sugar comprises allulose.

Clause 46. The method according to any one of clauses 41-45, wherein a conching duration is an entire conching time within a range of 2.5-4.0 hours.

Clause 47. The method of any one of clauses 41-45, wherein the predetermined conching temperature is in a range of 40-48° C.

Clause 48. The method according to any one of clauses 41-45, wherein conching is conducted in at least an initial stage and a second stage over a period within a range of 2.5-4 hours, and the predetermined conching temperature is 50° C. or less in the initial stage and >50° C. in the second stage.

Clause 49. The method of clause 48, wherein the predetermined conching temperature in the initial stage is in the range of 40-48° C.

Clause 50. The method according to any one of clauses 41-49, wherein an emulsifier/surfactant content is from about 0.5% to about 0.9% by weight.

Clause 51. The method according to any one of clauses 41-49, wherein the emulsifier/surfactant comprises a combination of lecithin and PGPR, said combination having a content of lecithin of about 0.3% to about 0.6% by weight, and a content of PGPR of about 0.2% to about 0.3% by weight.

Clause 52. The method according to any one of clauses 41-49, wherein the emulsifier/surfactant comprises a combination of lecithin and PGPR, said combination having a content of about 0.6% lecithin by weight and about 0.3% PGPR by weight, and the white chocolate having a moisture content of about 1.2% to about 2.0% by weight.

Clause 53. The method according to clause 45, wherein the method further comprises an additional conching step at a predetermined temperature for a predetermined time to reduce moisture to less than about 2.0% by weight.

Clause 54. The method according to any one of clauses 41-53, further comprising adding a whitening agent or a bulk filler which comprises a protein content of less than 20.0% by weight.

Clause 55. The method according to clause 54, comprising adding a bulk filler, wherein the protein content of the white chocolate is less than 1.0%.

Clause 56. The method according to clause 54, wherein there is substantially no discoloration at elevated storage temperatures from above 40° C. for at least one week as measured by ΔE≤3.0.

Clause 57. The method according to clause 48, wherein there is substantially no formation of agglomerates.

Clause 58. The method according to anyone of clauses 41-44 and 46-54, wherein the rare sugar comprises tagatose, said method further comprising adding a bulk filler wherein the bulk filler comprises a protein content of less than 20.0% by weight.

Clause 59. The method according to clause 58, wherein the protein content of the white chocolate is less than 1.0%.

Clause 60. The method according to clause 59, wherein there is substantially no discoloration at elevated storage temperatures from above 40° C. for at least one week as measured by ΔE≤3.0. The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not each method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A white chocolate confectionery product having a reduced sugar content comprising:
a fat ingredient,
a sweetener comprising at least one rare sugar, or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, D-mannose, trehalose, and kojibiose,
an emulsifier/surfactant; and
an optional dairy ingredient, bulk filler, intense sweetener, whitening agent, and/or flavor,
wherein the white chocolate confectionery product has a stable apparent viscosity at 40° C. and 20 rpm (as measured by Brookfield viscometer) of 1,000 to 15,000 cp; a stable plastic viscosity at 40° C. using the National Confectionery Association and Chocolate Manufacturers Association (NCA/CMA) Casson regression model of 500 to 10,000 cp, and a stable yield value at 40° C. using the NCA/CMA Casson regression model of 0.5-150 dynes/cm².

2. The white chocolate confectionery product according to claim 1, having stable apparent viscosity, stable plastic viscosity, and stable yield value at temperatures of from about 100° F. (38° C.) for at least two weeks.

3. The white chocolate confectionery product according to claim 1, having stable apparent viscosity, stable plastic viscosity, and stable yield value at a temperature of from 100° F. (38° C.) to about 113° F. (45° C.) for up to 4 weeks.

4. The white chocolate confectionery product according to claim 1, wherein there is substantially no discoloration at elevated storage temperatures from above 40° C. for at least one week as measured by ΔE≤3.0.

5. The white chocolate confectionery product according to claim 1, wherein the at least one rare sugar comprises allulose.

6. The white chocolate confectionery product according to claim 5, having a fat content of about ≥30% by weight.

7. The white chocolate confectionery product according to claim 5, having a moisture content of less than about 2.0% by weight.

8. The white chocolate confectionery product according to claim 5, having an emulsifier/surfactant content of about 0.5% to about 0.9% by weight.

9. The white chocolate confectionery product according to claim 5, comprising a bulk filler, wherein the bulk filler is selected from the group consisting of flour, starch, fiber, polydextrose, fructooligosaccharides, inulin, dextrin, sugar alcohols, and combinations or mixtures thereof.

10. The white chocolate confectionery product according to claim 9, wherein the bulk filler comprises a protein content of less than 20.0% by weight.

11. The white chocolate confectionery product according to claim 10, comprising a protein content of less than 1.0%.

12. The white chocolate confectionery product according to claim 5, further comprising a whitening agent.

13. A method for making a white chocolate confectionery product having a reduced sugar content, the method comprising:
mixing a predetermined amount of a fat ingredient and a predetermined amount of sweetener comprising at least one rare sugar or a combination of at least one rare sugar and at least one standard nutritive carbohydrate sugar, wherein the at least one rare sugar is selected from the group consisting of allulose, tagatose, allose, sorbose, apiose, ribose, L-rhamnose, L-fructose, and D-mannose, and other dry bulk ingredients to obtain a fat/sweetener/bulk mixture;
refining the fat/sweetener/bulk mixture to obtain a particle size of <60 μm;
adding a predetermined amount of emulsifier/surfactant to the fat/sweetener mixture;
conching at a conching temperature of less than 50° C. for a predetermined conching time; and
standardizing with remaining emulsifiers/surfactants and fats,
wherein the white chocolate confectionery product has a stable apparent viscosity at 40° C. and 20 rpm (as measured by Brookfield viscometer) of 1,000 to 15,000 cp a stable plastic viscosity at 40° C. using the National Confectionery Association and Chocolate Manufacturers Association (NCA/CMA) Casson regression model of 500 to 10,000 cp, and a stable yield value at 40° C. using the NCA/CMA Casson regression model of 0.5-150 dynes/cm².

14. The method according to claim 13, having stable apparent viscosity, stable plastic viscosity, and stable yield value at temperatures of from about 100° F. (38° C.) for at least two weeks.

15. The method according to claim 13, wherein the at least one rare sugar comprises allulose.

16. The method according to claim 15, wherein a fat content is about ≥30% by weight.

17. The method according to claim 15, wherein a moisture content is less than about 2.0% by weight.

18. The method according to claim 15, wherein an emulsifier/surfactant content is from about 0.5% to about 0.9% by weight.

19. A method of preventing or inhibiting thickening of white chocolate which comprises a sweetener comprising at least one rare sugar or a combination of at least one rare sugar and at least one standard nutritive carbohydrate sugar, said method comprising:
conching at a temperature of less than 50° C. for a predetermined time;
adding fat in an amount of about 30% by weight or more, overdosing the white chocolate with an emulsifier/surfactant, and/or adjusting total moisture of the white chocolate to below 2.0%, wherein the at least one rare sugar is selected from the group consisting of allulose, tagatose, allose, sorbose, apiose, ribose, L-rhamnose, L-fructose, D-mannose, trehalose, and kojibiose; and
wherein the white chocolate has a stable apparent viscosity at 40° C. and 20 rpm (as measured by Brookfield viscometer) of 1,000 to 15,0000 cp, a stable plastic viscosity at 40° C. using the NCA/CMA Casson regression model of 500 to 10,000 cp, and a stable yield value at 40° C. using the NCA/CMA Casson regression model of 1-150 dynes/cm².

20. The method according to claim 19, having stable apparent viscosity, stable plastic viscosity, and stable yield value at temperatures of from about 100° F. (38° C.) for at least two weeks.

21. The method according to claim 20, wherein the rare sugar comprises allulose.
